(19) United States
(12) Patent Application Publication
(10) Pub. No.: US 2012/0143103 A1
(43) Pub. Date: Jun. 7, 2012

(54) Range of Motion and Similar Devices with Temperature Controlled Fluids

(75) Inventors: Thomas P. Branch, Atlanta, GA (US); Fredrik Westin, Atlanta, GA (US); Edward Dittmar, Marietta, GA (US); Cale Jacobs, Suanee, GA (US)

(73) Assignee: ERMI, Atlanta, GA (US)

(21) Appl. No.: 13/269,289

(22) Filed: Oct. 7, 2011

Related U.S. Application Data
(63) Continuation-in-part of application No. 13/018,992, filed on Feb. 1, 2011.
Application No. 13/018,992 is a continuation of application No. 12/328,539, filed on Dec. 4, 2008, now abandoned.
Application No. 12/328,539 is a continuation of application No. 10/720,023, filed on Nov. 19, 2003, now Pat. No. 7,479,121.
Application No. 10/720,023 is a continuation of application No. 09/779,329, filed on Feb. 8, 2001, now Pat. No. 6,669,660.
Application No. 09/779,329 is a continuation of application No. PCT/US99/18074, filed on Aug. 10, 1999.
(60) Provisional application No. 61/390,868, filed on Oct. 7, 2010.
(60) Provisional application No. 60/096,105, filed on Aug. 10, 1998.
(60) Provisional application No. 60/096,104, filed on Aug. 10, 1998.
(60) Provisional application No. 60/095,952, filed on Aug. 10, 1998.

(51) Int. Cl. A61H 1/00; A61H 7/00

(52) U.S. Cl. 601/18; 601/148

(57) ABSTRACT

Various orthotic devices for attachment to and for manipulating a user's limb having a joint are provided. The device generally comprises an inflatable motive bladder containing a first fluid and positioned adjacent a first portion of the user's limb, and a separate therapy pad positioned adjacent a second portion of the user's limb. The motive bladder is inflatable from a lesser inflated mode to a more inflated mode, and further configured to provide a motive force to move the first portion of the user's limb so as to cause a flexion in the joint. The therapy pad includes a treatment material configured to provide thermotherapy for the second portion of the user's limb. In certain embodiments, the second portion is the user's joint. Various methods of using the orthotic devices are also provided.

### CROSS-REFERENCE TO RELATED APPLICATIONS

This application is a continuation-in-part of U.S. application Ser. No. 13/018,992, filed Feb. 1, 2011, which is a continuation of U.S. application Ser. No. 12/328,539, filed Dec. 4, 2008, now abandoned, which is itself a continuation of U.S. application Ser. No. 10/720,023, filed Nov. 19, 2003, now U.S. Pat. No. 7,479,121, which is itself a continuation of U.S. application Ser. No. 09/779,329, filed Feb. 8, 2001, now U.S. Pat. No. 6,669,660, which is itself a continuation of PCT/US99/18074, filed on Aug. 10, 1999, and claims further priority to U.S. Provisional Application No. 60/096,105, filed Aug. 10, 1998, U.S. Provisional Application No. 60/096,104, filed Aug. 10, 1998, and U.S. Provisional Application No. 60/095,952, filed Aug. 10, 1998. The present application claims the benefit and priority of each of the applications noted above, all of which are incorporated in their entirety hereby by reference.

The present application also further claims priority to and the benefit of U.S. Provisional Application No. 61/390,868, filed Oct. 7, 2010, entitled “Range of Motion and Similar Devices with Temperature Controlled Fluids,” which is likewise incorporated herein in its entirety.

### BACKGROUND

1. Field of Invention

This invention relates generally to orthotic devices and more particularly to orthotic devices designed to promote an increase in range of motion in a joint by the use of selectively inflatable and deflatable bladders.

2. Description of Related Art

When a joint is injured either by trauma or by surgery scar tissue can form which prevents full range of motion of that joint. Obviously, this is a disadvantageous condition and should be corrected if possible. Often, such correction involves an attempt by the injured or those assisting the injured to gradually (often over a period of months) manipulate the joint so that full range of motion is eventually achieved.

Full range of motion of a joint depends upon the anatomy of that joint and on the particular genetics of each individual. Typically, joints move in two directions, flexion and extension. Typically, flexion is to bend the joint and extension is to straighten the joint; however, in the orthopedic convention some joints only flex. For example, the ankle has dorsiflexion and plantar-flexion. Other joints not only flex and extend, they rotate. For example, the elbow joint has supination and pronation, which is rotation of the hand about the longitudinal axis of the forearm placing the palm up or the palm down.

There is a need for a class of orthotics which promote an increase in range of motion of the joint rather than to merely provide support.

There are other devices available which use inflatable bladders around a joint. They tend to use the bladder(s) to provide support across the joint. Such inflatable bladders are positioned across the joint or in near proximity to the joint.

Such conventional orthosis devices may be designed for support across a joint. In general an orthosis connects one limb segment to another across a joint. The connection is either a rigid member or a hinged joint. In this way orthotics work to support the joint as a means of protecting it. General reference is made to U.S. Pat. Nos. 5,542,911, 5,378,224, 5,348,530, and 5,730,710.

One particular device which uses the bladder(s) to provide support across the joint is also shown in U.S. Pat. No. 5,514,081 to Mann, which uses the inflatable bladder to cross the elbow joint to provide support for an elbow with a flexion contracture (the elbow joint cannot fully extend). This device places the inflatable bladder across the joint so that when it inflates it holds the elbow in full extension. This device does not appear to include rigid structural members. Further, it does not isolate the bladder distant to the joint, thus maximizing the biomechanical forces across the joint for promoting elbow extension.

U.S. Pat. No. 3,581,740 has an air bladder which crosses multiple finger joints of a hand as well as the wrist. Upon inflation, the hand is moved to a normally extended, spaced apart, condition.

Some prior art patents use inflatable members to gain range of motion in the hand. U.S. Pat. No. 4,671,258 uses a cyclical therapeutic joint exerciser by inflating a pouch that crosses the joint and a spring steel insert that automatically bends the joint when the inflatable pouch is not inflated. U.S. Pat. No. 4,807,606 uses bladders around the joints in the 3 hands to exercise the joints. That is to say, the bladders are inflated and deflated sequentially with a pump device to flex and extend hand joints.

U.S. Pat. No. 5,056,504 uses the inflatable bladder in the palm against a rigid structure to push the fingers into extension. However, this U.S. Pat. No. 5,056,504 patent includes a bladder which “crosses the joint”, which is not only potentially painful to the user if the joint has undergone surgery, but is not optimally biomechanically efficient in the distribution of forces as will be described later with respect to applicant's invention.

Further, at least U.S. Pat. No. 7,874,996 uses inflatable bladders to gain range of motion in a user's toe(s).

While it may be seen that there is a need in the art to provide an improved orthotic device, various embodiments of which may be used to bend and/or straighten limbs or joints, there is also a need in the art to improve the efficacy of such devices through the combined use of thermotherapy. Thermotherapy is generally defined as the use of thermal agent to cause a physiologic change within the tissue to promote or create a more advantageous healing environment. Thermal agents may provide therapeutic benefit by either being at a higher or lower temperature than the tissue being treated. Thermal agents with higher temperatures promote greater gains in joint range of motion by increasing tissue extensibility and reducing pain. Thermal agents with lower temperatures provide the therapeutic benefit of decreased pain and decreased inflammation.

Therefore, it may be seen that there is a need in the art to provide an improved orthotic device, which can be used to straighten (“orthoun” means to straighten) limbs or joints, while simultaneously allowing the selective heating or cooling of the tissues being stretched by the device.

It may further be seen that there is a need in the art for an improved orthotic device and method of using same which provides optimal biomechanical distribution of load while providing the afore-mentioned simultaneous application of thermotherapy.

### SUMMARY

Generally described, the present invention provides an orthotic device and method of using same to straighten limbs or joints.

In accordance with various embodiments of the present invention as described herein, an orthotic device for attachment to and for manipulating a user's limb having a joint is provided. The device comprises: an inflatable motive bladder containing a first fluid, the bladder inflatable from a lesser inflated mode to a more inflated mode, the motive bladder configured to be positioned adjacent a first portion of the limb, the motive bladder configured to provide a motive force to move the first portion of the limb so as to cause a change in flexion or extension in the joint; and a therapy pad adjacent a second portion of the limb, the therapy pad being separate and spaced from the motive bladder and comprising a treatment material configured to provide thermotherapy for the second portion of the limb.

Further, in accordance with various embodiments of the present invention as described herein, an orthotic device for attachment to and for manipulating a user's limb having a joint is provided. The device comprises: an inflatable motive bladder containing a first fluid, the bladder inflatable from a lesser inflated mode to a more inflated mode, the motive bladder configured to be positioned adjacent a first portion of the limb, the motive bladder configured to provide a motive force to move the first portion of limb so as to cause a change in flexion or extension in the joint; a first therapy pad adjacent a second portion of the limb, the first therapy pad being separate and spaced from the motive bladder and configured to provide thermotherapy for the second portion of the limb; and a second therapy pad adjacent a third portion of the limb, the second therapy pad being separate and spaced from the motive bladder and configured to provide thermotherapy for the third portion of the limb.

Still further, in accordance with various embodiments of the present invention as described herein, an orthotic device for attachment to and for manipulating a user's limb having a joint is provided. The device comprises: an inflatable motive bladder containing a first fluid, the bladder inflatable from a lesser inflated mode to a more inflated mode, the motive bladder configured to be positioned adjacent a first portion of the limb, the motive bladder configured to provide motive force to move the first portion of limb so as to cause a change in flexion or extension in the joint; and a therapy pad adjacent a second portion of the limb, the therapy pad being separate and spaced from the motive bladder and configured to provide thermotherapy for the second portion of the limb, the second portion of the limb including the joint under flexion or extension.

In accordance with still other various embodiments of the present invention as described herein, an orthotic device for attachment to and for manipulating a user's limb having a joint is provided. The device comprises: an inflatable motive bladder containing a first fluid, the bladder inflatable from a lesser inflated mode to a more inflated mode, the motive bladder configured to be positioned adjacent a first portion of the limb, the motive bladder configured to provide motive force to move the portion of limb so as to cause a change in flexion or extension in the joint; and a separate therapy pad adjacent a second portion of the limb, the therapy pad being separate from the motive bladder and including a second fluid, the first fluid configured to inflate the motive bladder and also configured to provide thermotherapy for the first portion of limb such that there is fluid communication between the motive bladder and the therapy pad.

In accordance with still other various embodiments of the present invention as described herein, an orthotic device for attachment to and for manipulating a user's limb having a joint is provided. The device comprises an inflatable motive bladder containing a first fluid, wherein: the bladder is configured to be positioned adjacent a portion of the limb; the bladder is configured to provide a motive force upon the portion of the limb and cause a change in flexion or extension in the joint; the first fluid is configured to inflate the bladder from a lesser inflated mode to a more inflated mode, so as to provide the motive force; and the first fluid is further configured to provide thermotherapy for the portion of the limb.

In accordance with various embodiments of the present invention as described herein, a method for manipulating a user's limb having a joint is provided. The method comprises the steps of: positioning an inflatable motive bladder containing a first fluid adjacent a first portion of the limb, the bladder being inflatable from a lesser inflated mode to a more inflated mode; positioning a separate therapy pad adjacent a second portion of the limb, the therapy pad being spaced from the motive bladder and including a treatment material configured to provide thermotherapy for the second portion of the limb; and inflating the motive bladder from the lesser inflated mode to the more inflated mode, such that the motive bladder provides a motive force to move at least the first portion of the limb so as to cause a change in flexion or extension in the joint.

In accordance with still further various embodiments of the present invention as described herein, a method for manipulating a user's limb having a joint is provided. The method comprises the steps of: positioning an inflatable motive bladder containing a first fluid adjacent a first portion of the limb, the bladder being inflatable from a lesser inflated mode to a more inflated mode; positioning a first separate therapy pad adjacent a second portion of the limb, the first therapy pad being spaced from the motive bladder and including a treatment material configured to provide thermotherapy for the second portion of the limb; positioning a second separate therapy pad adjacent a third portion of the limb, the second therapy pad being spaced from the motive bladder and the first therapy pad, the second therapy pad including a treatment material configured to provide thermotherapy for the third portion of the limb; and inflating the motive bladder from the lesser inflated mode to the more inflated mode, such that the motive bladder provides a motive force to move at least the first portion of the limb so as to cause a change in flexion or extension in the joint.

In accordance with still further various embodiments of the present invention as described herein, a method for manipulating a user's limb having a joint is provided. The method comprises the steps of: positioning an inflatable motive bladder containing a first fluid adjacent a first portion of the limb, the bladder being inflatable from a lesser inflated mode to a more inflated mode; positioning a separate therapy pad adjacent the joint, the therapy pad being spaced from the motive bladder and including a treatment material configured to provide thermotherapy for the joint; and inflating the motive bladder from the lesser inflated mode to the more inflated mode, such that the motive bladder provides a motive force to move at least the first portion of the limb so as to cause a change in flexion or extension in the joint.

It is a further aspect of the present invention to provide an orthotic device which provides an optimal biomechanical application and distribution of load.

It is a further aspect of the present invention to provide an improved orthotic device which is easy to use.

It is a further aspect of the present invention to provide an improved orthotic device which is simple to manufacture. It is a further aspect of the present invention to provide an improved orthotic device which applies no direct pressure on the joint itself.

It is a further aspect of the present invention to provide an improved orthotic device which is cost-effective to manufacture and use.

It is a further aspect of the present invention to provide an improved orthotic device which is efficient in its use of forces.

It is a further aspect of the present invention to provide an orthotic device which has increased reliability.

It is a further aspect of the present invention to provide an orthotic device which is easy to apply and remove.

It is a further aspect of the present invention to provide an orthotic device which allows for instant release of pressure.

It is a further aspect of the present invention to provide an orthotic device which provides a high load application

It is a further aspect of the present invention to provide an orthotic device which provides an efficient load application. It is a further aspect of the present invention to provide an orthotic device which applies comfortable pressure.

It is a further aspect of the present invention to provide an improved orthotic device which is light in weight and easy to transport.

It is a further aspect of the present invention to provide an improved orthotic device which can be used in conjunction with a crutch for structural support.

Other aspects, features, and advantages of the present invention will become apparent upon reading the following detailed description of the preferred embodiment of the invention when taken in conjunction with the drawing and the appended claims.

### BRIEF DESCRIPTION OF THE DRAWINGS

Having thus described the invention in general terms, reference will now be made to the accompanying drawings, which are not necessarily drawn to scale, and wherein:

FIG. 1 is a side view of a knee extension assembly 10 and an ankle support member 30 used in conjunction with a conventional crutch 12, manipulating the leg 12 of a user;

FIG. 2 is a side view, similar to that of FIG. 1 but more close up, of a knee extension assembly embodiment 100;

FIG. 3 is a top view of an unfolded, uninstalled, knee extension assembly embodiment 100, which includes the same bladder 20 and straps 25 as shown in FIG. 1, but also includes an attachment/protective pad 112 and a therapy/treatment pad 114 having a pocket 115;

FIG. 4 is a side perspective view of the knee extension assembly embodiment 100, with the pads 112 and 114 folded around to simulate their installed configuration;

FIG. 5 is a side perspective view of a knee extension assembly embodiment 200, which includes an attachment pad 212 and a therapy/treatment pad 214;

FIG. 6 is a side perspective view of a knee extension assembly embodiment 300, which includes a temperature treatment extension 310;

FIG. 7 is a side perspective view of a knee extension assembly embodiment 400, which includes an alternative temperature treatment extension 410.

FIG. 8 is a side view of a knee extension assembly embodiment 500, which includes a temperature treatment extension 510;

FIG. 9 is a side view of a knee extension assembly embodiment 100, which includes a temperature treatment extension 610;

FIG. 10 is a top perspective view of the unfolded, uninstalled, knee extension assembly embodiment 100 of FIG. 3, but having a slight variation of a pocket 113 in the attachment/protective pad 112;

FIG. 11 is a top perspective view of the folded, installed, knee extension assembly embodiment 100 of FIG. 4;

FIG. 12 is a top perspective view of the knee extension assembly embodiment 200 of FIG. 5, but with further detail of a particular variation having a unitary inlet/outlet portion 217 used in conjunction with the integral heat transfer channels 215; and

FIG. 13 is a top perspective view of the knee extension assembly embodiment 200 of FIG. 5, but with further detail of a particular variation having a separate inlet portion 218 and a separate outlet portion 219, each used in conjunction with the integral heat transfer channels 215.

### DETAILED DESCRIPTION OF VARIOUS EMBODIMENTS

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Reference is now made to the Figures, in which like elements indicate like elements throughout the several views.

The application will be discussed by reference to several different embodiments, which may share inventive concepts or alternately may each include individual inventive concepts.

### I. GENERAL SUMMARY

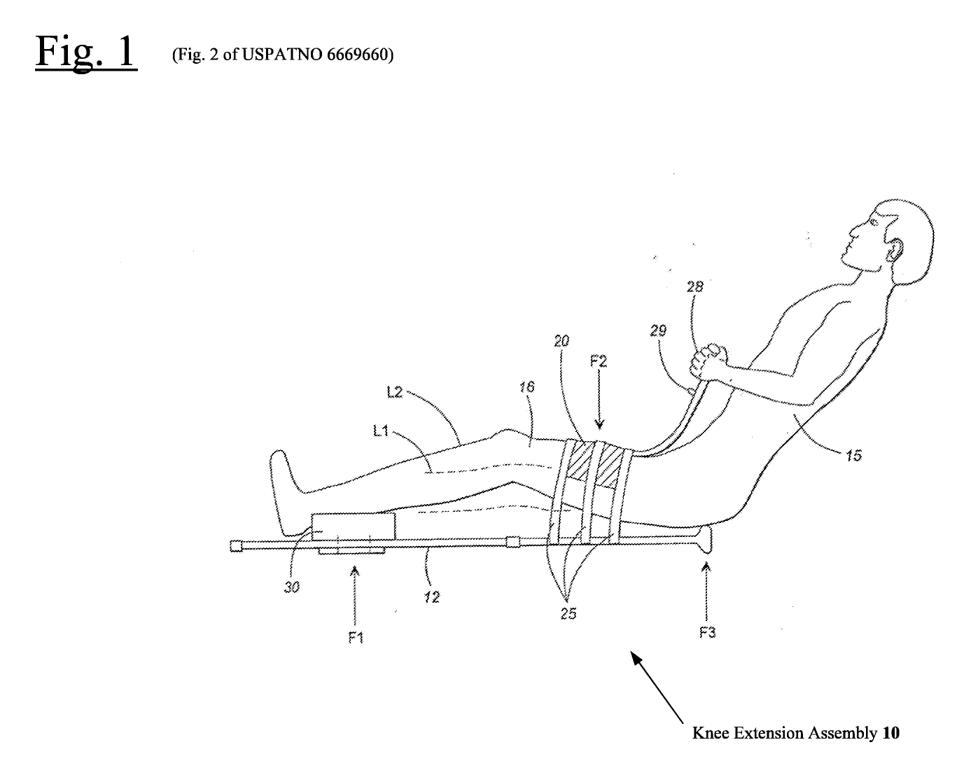

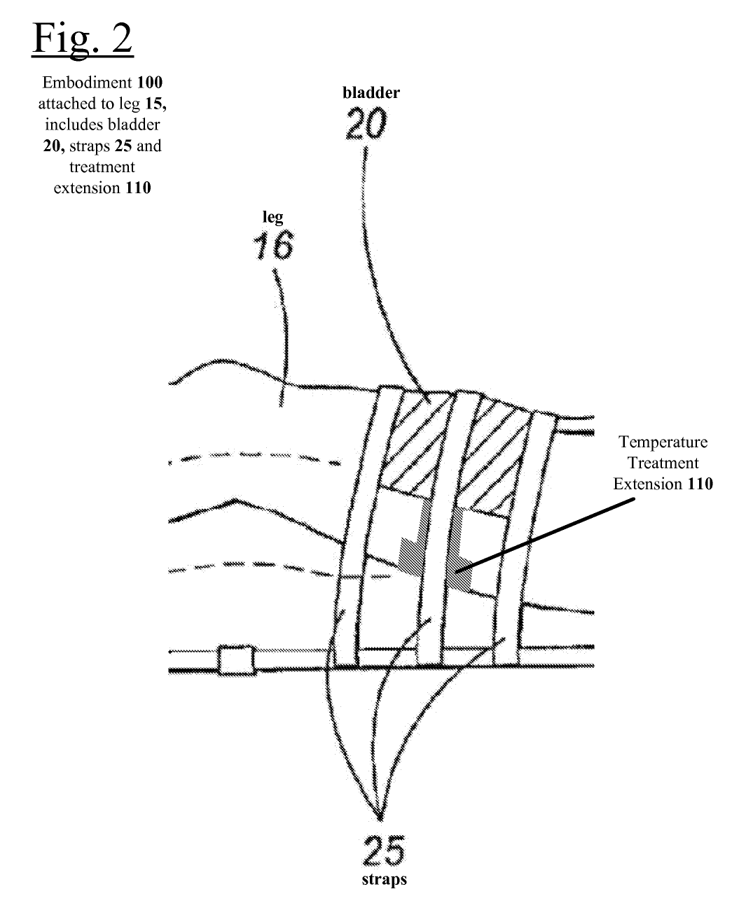

Generally described, the present invention relates to the use of temperature treatment extensions of various embodiments, which can be used in conjunction with therapeutic devices which may include the use of fluids for motive means. One example is a knee extension assembly 10 and an ankle support member 30 used in conjunction with a conventional crutch 12, manipulating the leg 12 of a user as shown in FIG. 1, which is FIG. 2 of U.S. Pat. No. 6,669,660, which is hereby incorporated by reference herein in its entirety. Under various embodiments of the invention, hot or cold fluid can also be used to provide “double duty” in filling up the bladder 20, but also by providing thermotherapy through the attached temperature treatment extensions.

Various additional embodiments are shown which include the above concepts, but also show additional inventions.

### II. ELEMENTS LIST

The invention is configured to be used by a patient/user 5. The elements of the invention include the following:

FIG. 1
Bladder 20
Leg 16
Straps 25

FIGS. 2, 3, 4
Knee Extension Assembly Embodiment 100
Bladder 20
Leg 16
Straps 25
Temperature Treatment Extension 110
Attachment/Protective Pad 112
Pocket 113
Therapy/Active Pad 114
Pocket 115

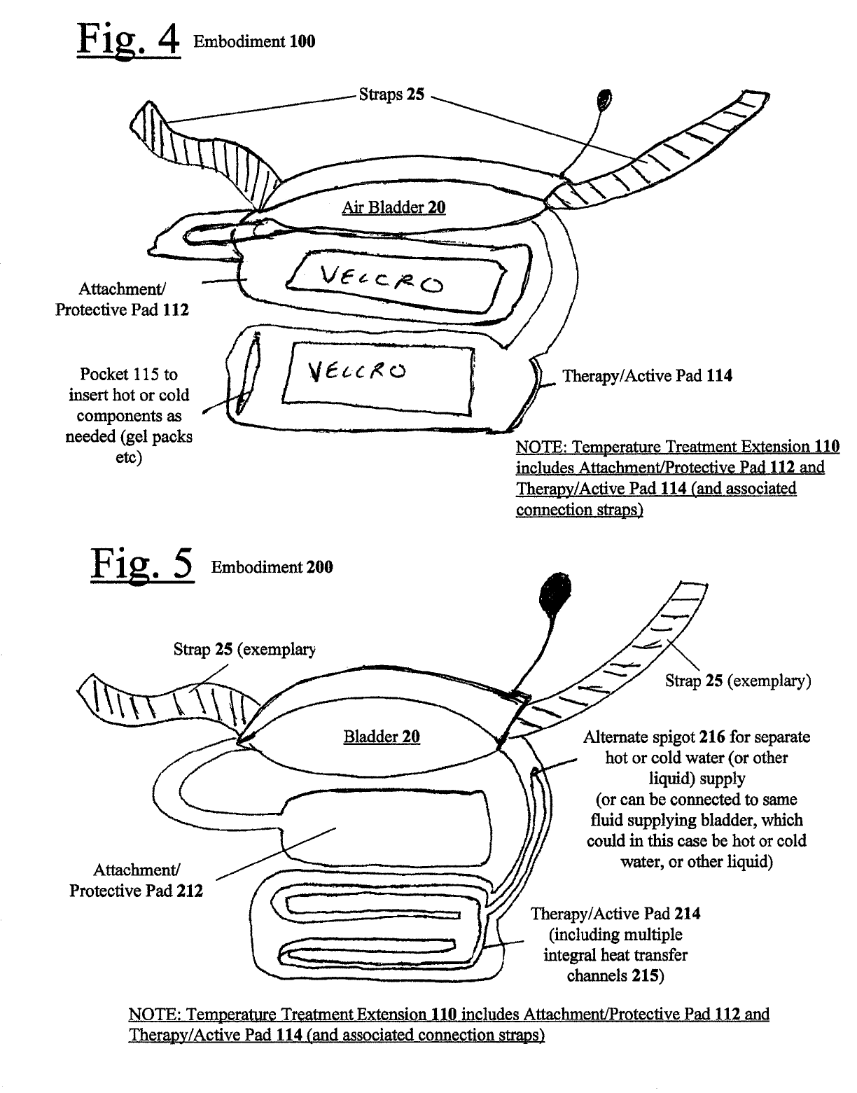

FIG. 5
Knee Extension Assembly Embodiment 200
Bladder 20
Leg 16
Straps 25
Temperature Treatment Extension 210
Attachment/Protective Pad 212
Therapy/Active Pad 214
Heat Transfer Channels 215
Alternate Spigot 216
Unitary Inlet/Outlet Portion 217
Separate Inlet Portion 218
Separate Output Portion 219

FIG. 6
Knee Extension Assembly Embodiment 300
Bladder 20
Leg 16
Straps 25
Temperature Treatment Extension 310
Therapy/Active Pad 314
Elastic 317

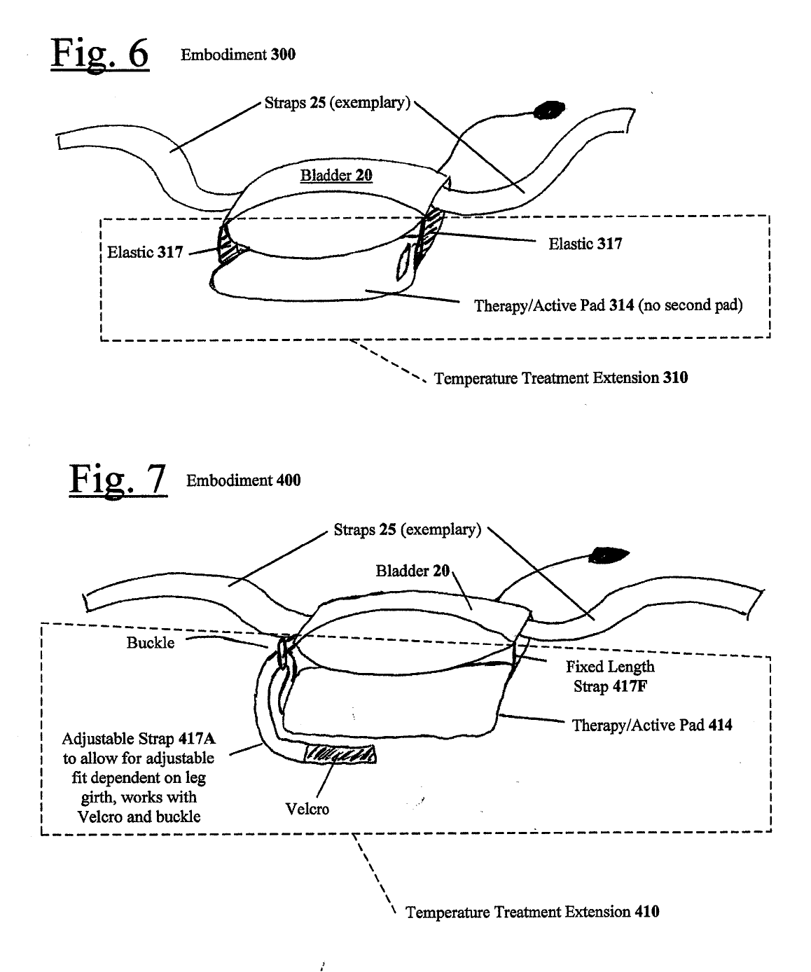

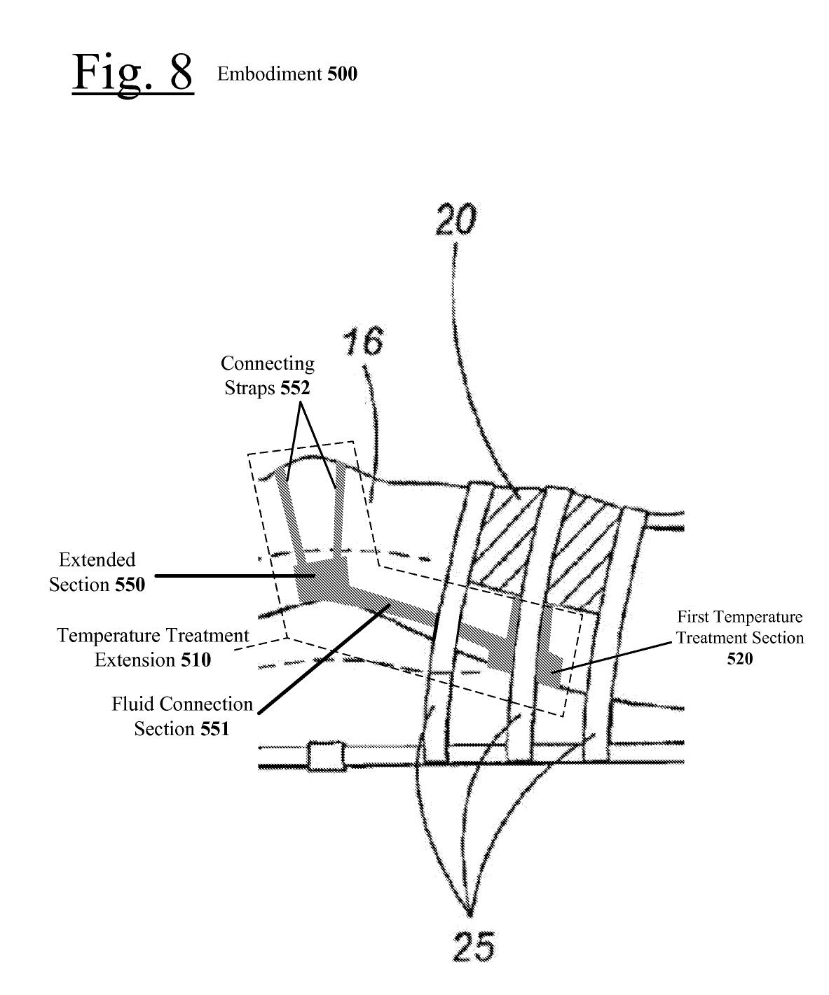

FIG. 7
Knee Extension Assembly Embodiment 400
Bladder 20
Leg 16
Straps 25
Temperature Treatment Extension 410
Therapy/Active Pad 414
Adjustable Length Strap 417A
Fixed Length Strap 417F

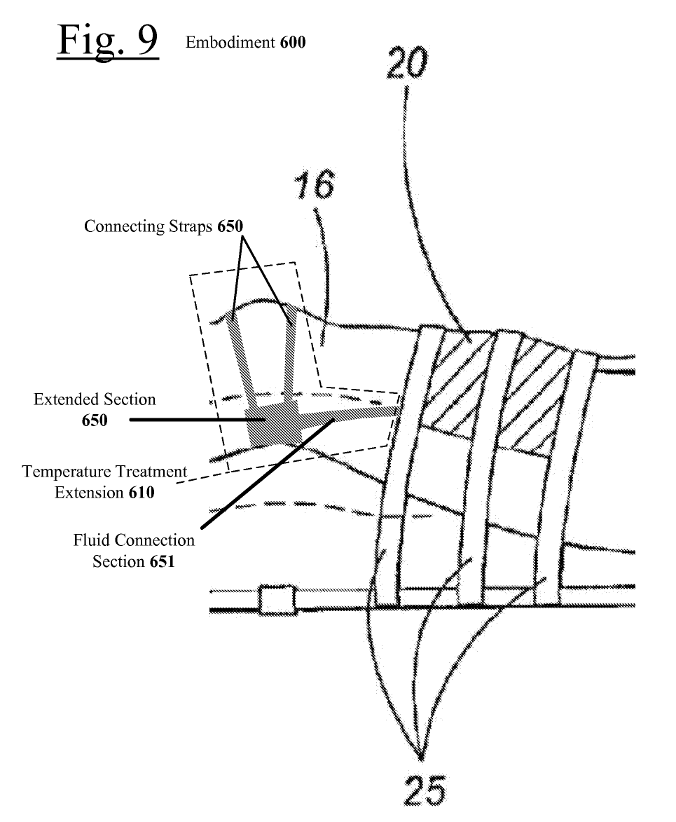

FIG. 8
Knee Extension Assembly Embodiment 500
Bladder 20
Leg 16
Straps 25
Temperature Treatment Extension 510
Extended Section 550
Fluid Connection Section 551
Connecting Straps 552

FIG. 9
Knee Extension Assembly Embodiment 600
Bladder 20
Leg 16
Straps 25
Temperature Treatment Extension 610
Extended Section 650
Fluid Connection Section 651
Connecting Straps 652

### III. DETAILS

Here follows a discussion of specific embodiments. By way of introduction, reference is first made to FIG. 1, which provides a side view of a knee extension assembly 10 and an ankle support member 30 according to various embodiments, as used in conjunction with a conventional crutch 12, manipulating the leg 12 of a user. FIG. 1 is FIG. 2 of U.S. Pat. No. 6,669,660, to which priority, in part, is claimed and which is hereby incorporated by reference herein in its entirety. According to various embodiments, the knee extension assembly 10 comprises at least a bladder 20 and a plurality of straps 25. As will be understood based upon further detail disclosed below, various embodiments of the present invention represent various modifications to such a bladder-configured system. In certain embodiments the various modifications may comprise at least the addition of various temperature treatment extensions attached to and/or operating therewith.

Assembly 100

Reference is now made to FIG. 2, which provides a side view of a knee extension assembly 100, which comprises, according to various embodiments, not only the elements shown in FIG. 1, but also at least a temperature treatment extension 110. In certain embodiments, the temperature treatment extension 110 may be operatively attached to the inflatable bladder, while in other envisioned embodiments the extension may be removably or otherwise attached, as may be desirable for a particular application.

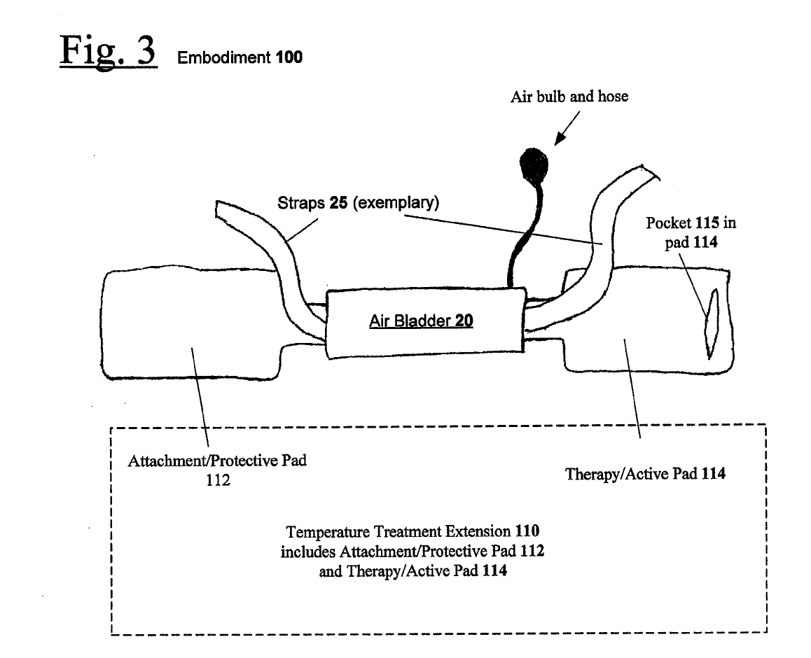

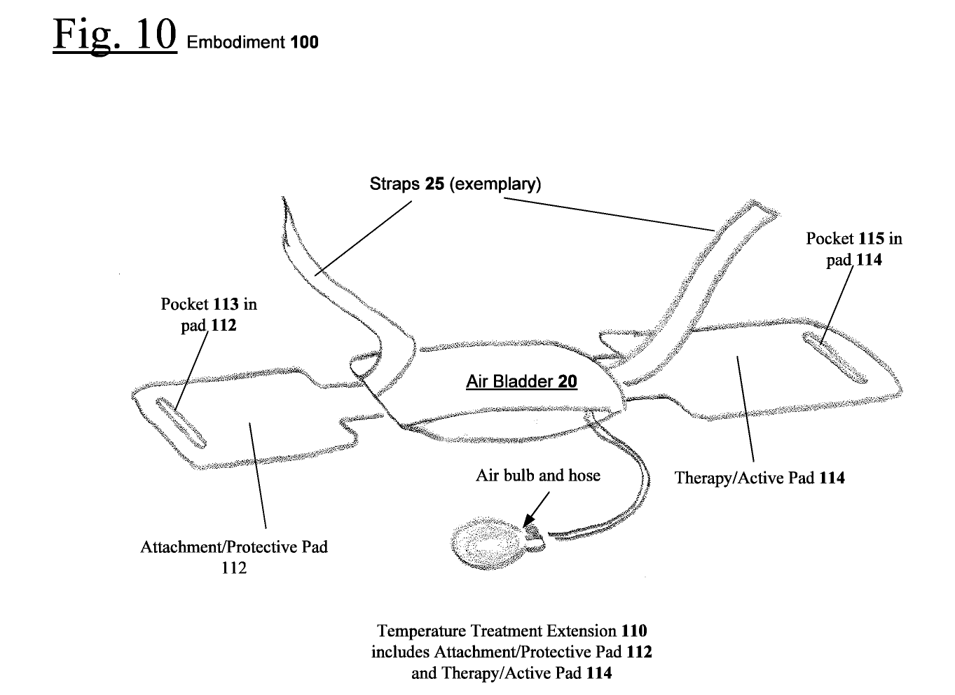

With particular reference to FIG. 3, an unfolded, uninstalled, knee extension assembly 100 is illustrated as comprising not only the same bladder 20 and straps 25 of FIG. 1, but also comprises an attachment/protective pad 112 and a therapy/treatment pad 114, each of which extend from respective opposing sides of the bladder 20. In certain embodiments, as illustrated further by FIG. 10, the pads 112, 144 are substantially rectangular-shaped, although in various alternatively envisioned embodiments, the pads may be shaped and sized in any of a variety of fashions, as commonly known or understood in the art and as may be desirable for a particular application.

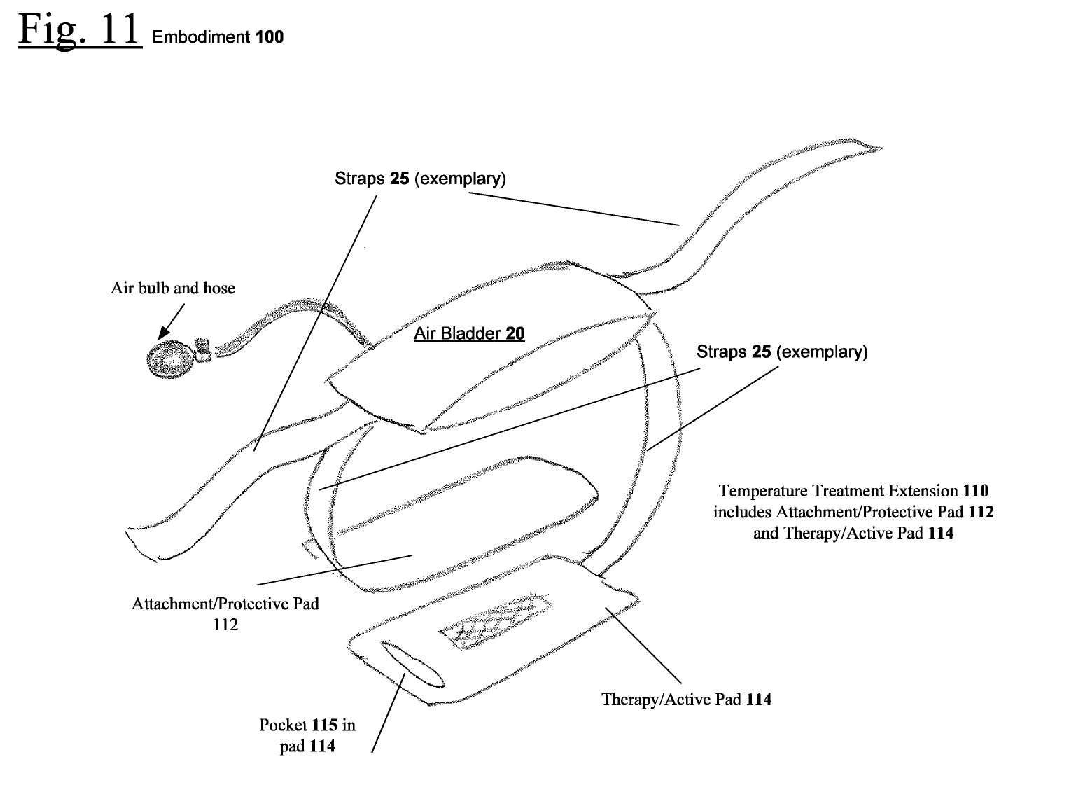

As may be understood from FIG. 4, according to various embodiments, either one or both of the pads 112, 114, may have Velcro (or any of a variety of alternative adhesive or attachment-type materials and/or mechanisms) located on one or more of their respective anterior and/or posterior surfaces. In certain embodiments, the Velcro or alternative adhesive or attachment mechanism allows for the attachment pad to be placed in between the therapy/active pad to prevent overheating/cooling. Returning to FIGS. 3 and 10, in other embodiments, the attachment pad 112 may also be placed posterior to the therapy/active pad 114 to increase overheating/cooling, as may be desirable for a particular application. In these and various other envisioned embodiments, as shown in at least FIG. 3, the therapy/treatment pad 114 may include at least one pocket 115 configured to accept a hot or cold modular thermotherapy insert, such as described elsewhere herein. In still other envisioned embodiments, such as illustrated in at least FIG. 10, the attachment/protective pad 112 may alternatively further include at least one pocket 113 configured to accept a hot or cold modular thermotherapy insert, as described above. Of course, in still other envisioned embodiments, alternative heating/cooling configurations are contemplated, such as multiple integral heat transfer channels, electronic heating/cooling elements, etc., as will be further described elsewhere herein. Returning now to FIG. 4, with reference likewise to FIG. 11, perspective views of the knee extension assembly 100 of FIG. 3 are provided; wherein further the attachment pad 112 and the therapy/treatment pad 114 are depicted, as folded around according to various embodiments so as to substantially simulate their installed configuration. In certain embodiments, as illustrated, the pads 112, 114 are configured so as to substantially wrap around a user's limb, although in other envisioned embodiments, the pads may only wrap partially around the user's limb. Still further, although usage with a user's leg is illustrated in at least FIG. 4, it should be understood that, in still other envisioned embodiments, the assembly 100 may be configured for use with any of a variety of user limbs and/or joints, including the non-limiting examples of leg, thigh, knee, ankle, toe, shoulder, elbow, arm, wrist, etc., as may be desirable for a particular application.

Assembly 200

FIG. 5 is a perspective view similar to FIG. 4, but of a knee extension assembly 200, which, according to various embodiments, comprises not only the same bladder 20 and straps 25 as shown in FIG. 1, but also an attachment pad 212 and a therapy/treatment pad 214. In certain embodiments, each of the pads 212, 214 extends from respective opposing sides of the air bladder 20. Each of the pads 212, 214 may, in certain embodiments, be configured substantially similar in shape and size to those of FIG. 3, while in other envisioned embodiments, the pads and/or any of a variety of further included features may be substantially differently configured.

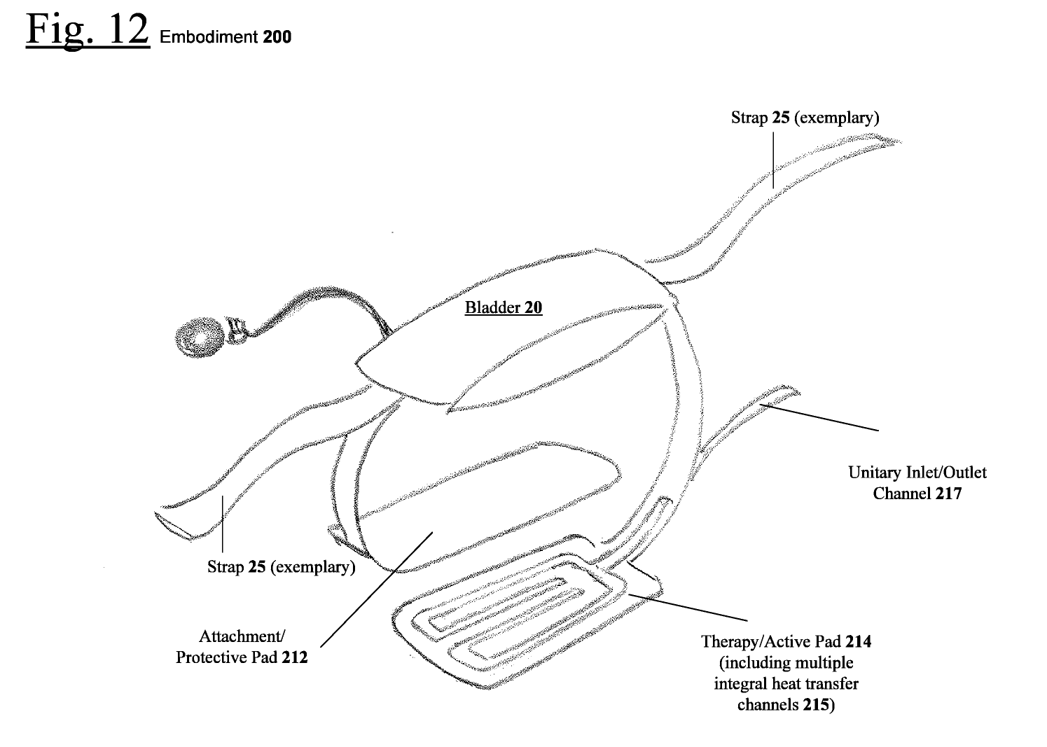

With reference to FIG. 12, it can further be seen that, according to various embodiments, the pads 212, 214 may be folded around into their installed configuration in which they wrap substantially around a user's limb (not shown, but consider, by analogy, FIG. 2). In certain embodiments, however, it should be appreciated that, as with the pads 112, 114, the pads 212, 214 may be alternatively configured so as to only partially wrap around (e.g., surround) the user's limb. Further, the pads 212, 214 may be used with any of a variety of user limbs (e.g., arms, legs, etc.) for treatment proximate any of a variety of user joints (e.g., finger, wrist, elbow, shoulder, hip, knee, ankle, toe, etc.), as previously described herein with regard to the pads 112, 114.

As with the pads 112, 114, the pads 212 and 214 of FIGS. 5 and 12 may be configured according to various embodiments such that they attach to each other (e.g., by Velcro or any of a variety of alternative adhesive or attachment mechanisms) in order to substantially position at least the treatment pad 21, as may be desirable for a particular application. In this and still other envisioned embodiments, such a configuration of the therapy/active pad 214 may comprise multiple integral heat transfer channels 215, each configured to provide a means to transfer heat from hot or cold fluid to the desired limb. It should be understood that, according to various embodiments, such hot or cold fluid may also be used to provide “double duty” in also filling up the bladder 20 with a comparable fluid, or could be used only in the pad 214 external to the bladder 20, while the bladder is filled with air (or some alternative gas or liquid other than the aforementioned hot or cold fluid). It should also be understood that in certain embodiments (not shown), the channels 215 may be replaced with an electronic heating/cooling element having a plurality of wires contained therein for heating/cooling the pad 214.

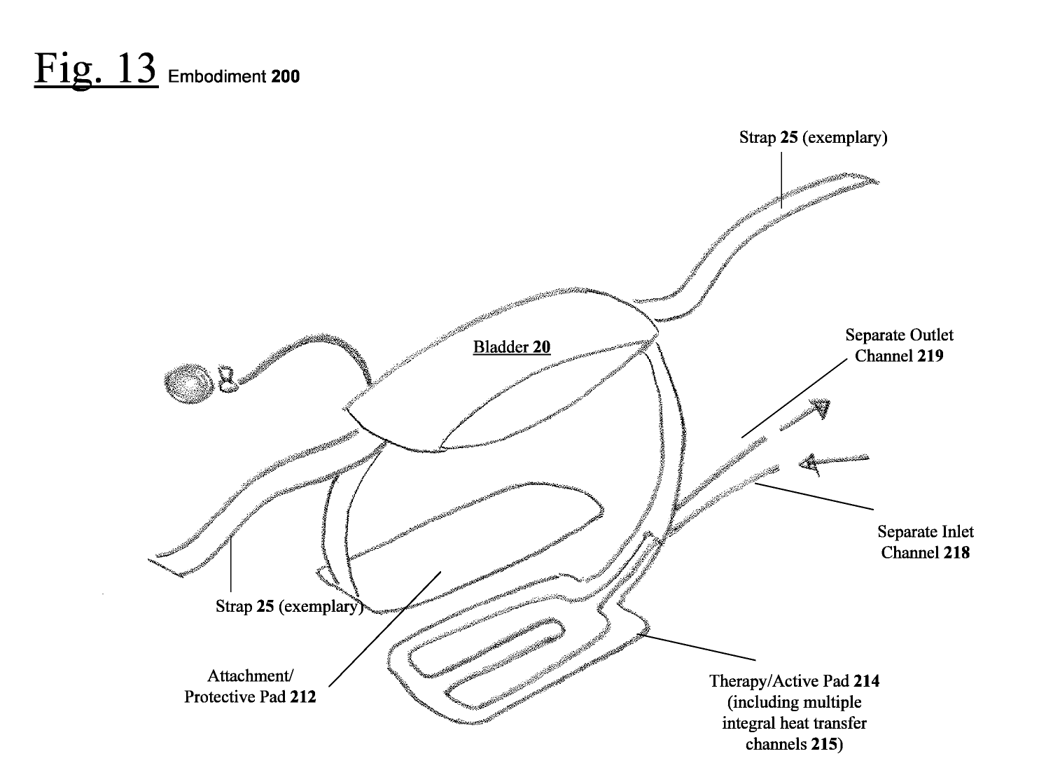

According to various embodiments, a spigot 216, as shown in FIG. 5 may be configured so as to allow for the alternate use of separate hot or cold water (or other fluid) to be supplied to the pad 214 and/or the bladder 20. In such configurations, as better understood with reference to FIG. 12, the hot or cold water could be supplied via a unitary inlet/outlet portion 217 (adjacent the spigot 216, if present) and into the channels 215 of the pad 214 prior to a treatment session. In these and still other envisioned embodiments, once supplied, the spigot 216, if present, could be closed, permitting the hot or cold water to remain stationary within the channels 215 during at least a portion of the treatment session, but for the influence of gravity, as may be desirable for particular applications. In various other embodiments, as may be understood from FIG. 13, the unitary inlet/outlet portion 217 of the channels 215 may be replaced with a separate inlet portion 218 and outlet portion 219. In these and still other such envisioned embodiments, instead of having a relatively stationary fluid within the pad 214, the fluid may be continuously cycled through the pad 214 for at least a portion of the treatment session. Such cycling may be according to various embodiments either by a gravity feed (one way) or by a recirculating feed. One example would be the Cryocuff configuration (see www.cryocuff.com).

Assembly 300

Turning now to FIG. 6, a knee extension assembly 300 according to various embodiments is illustrated. In certain embodiments, the assembly 300 comprises at least the bladder 20 and the straps 25 as shown in FIG. 1, plus at least a therapy/treatment pad 314. In various embodiments, the pad 314 may be held in place by at least two elastic straps 317, although various restraint mechanisms (e.g., other than elastic straps) may be envisioned and should be considered within the scope of the present invention.

According to certain embodiments of the assembly 300 of FIG. 6, no second pad is envisioned, as in previous assemblies (e.g., 100 and 200), although any of a variety of suitable insulating inserts (not shown) may be used if desirable for a particular application. In these and still other envisioned embodiments having such an insert, the insert(s) may be configured so as to protect the user from temperature extremes. Further, in at least the illustrated configuration, the therapy/active pad 314 may be configured to include at least one pocket to accept modular thermotherapy elements such as described elsewhere, or could include the multiple integral heat transfer channels as described elsewhere, or still further one or more electronic heating/cooling elements, as also described elsewhere herein.

In all other regards, the assembly 300 may be configured substantially the same as one or the other of assemblies 100 and/or 200, as may be desirable for a particular application. Further, as with assemblies 100, 200, various embodiments of the assembly 300 are envisioned for use with any of a variety of user limbs, although illustrated in conjunction with the non-limiting example of a user's leg.

Assembly 400

FIG. 7 is a perspective view similar to that of FIG. 4, but illustrating a knee extension assembly 400 according to various embodiments. In certain embodiments, the assembly 400 comprises at least the same bladder 20 and straps 25 as shown in FIG. 1, along with at least a temperature treatment extension 410. According to these and still other embodiments, the temperature treatment extension 410 may include a therapy/treatment pad 414 held in place by at least two straps. Of course, alternatively envisioned embodiments may replace the at least two straps with any of a variety of retention mechanisms, as may be desirable for a particular application.

Returning to FIG. 7, according to various embodiments, the at least two straps of the pad 414 may comprise at least a fixed length strap 417F and an adjustable strap 417A. In these and other envisioned embodiments, the straps 417F, 417A may be configured to allow for an adjustable fit, dependent on a user's limb (e.g., leg) girth.

Like the assembly 300 of FIG. 6, the assembly 400 of FIG. 7 according to certain embodiments need not necessarily include a second pad, as in previous assemblies (e.g., 100 and 200). In certain embodiments, however, any of a variety of suitable insulating inserts (not shown) may be used if desirable for a particular application. In these and still other envisioned embodiments having such an insert, the inert(s) may be configured so as to protect the user from temperature extremes. Further, in at least the illustrated configuration, the therapy/active pad 414 may be configured to include at least one pocket to accept modular thermotherapy elements such as described elsewhere, or could include the multiple integral heat transfer channels as described elsewhere.

In all other regards, the assembly 400 may be configured substantially the same as any of the previously described assemblies 100 and/or 200 and/or 300, as may be desirable for a particular application. Further, as with assemblies 100, 200, 300, various embodiments of the assembly 400 are envisioned for use with any of a variety of user limbs, although illustrated in conjunction with the non-limiting example of a user's leg.

Assembly 500

FIG. 8 is a side view, similar to that of FIG. 1 but illustrating a knee extension assembly 500 according to various embodiments. In certain embodiments, the assembly 500 comprises not only the elements of FIG. 1, but additionally a temperature treatment extension 510. In at least the illustrated and still other envisioned embodiments, the extension 510 may be fixedly, or alternatively removably attached to at least the inflatable bladder 20.

In any of these various embodiments, the temperature treatment extension 510 may include a first temperature treatment section 520, as well as an extended temperature treatment section 550. In certain embodiments, the extended section 550 may be configured so as to be in fluid communication with the first temperature treatment section 520. In at least the illustrated embodiment, such fluid communication is via a fluid connection section 551, although in alternatively envisioned embodiments, any of a variety of fluid connection mechanisms may be used or incorporated, as may be desirable for a particular application. In this manner, according to various embodiments, a temperature treatment may be applied to more than one location adjacent a user's limb, as may be desirable for a particular application.

According to various embodiments, either or both of the first temperature treatment section 520 and the extended section 550 may be configured so as to provide temperature treatment at the localized areas of the user's body as shown. In at least the illustrated embodiment, the extended section 550 can provide the treatment somewhat longitudinally distant from the bladder 20 location due the use of the connection section. In certain embodiments, the longitudinally distant location may be adjacent the user's joint. This configuration, as may be seen, is particularly useful when hot/cold fluid is used in the bladder 20 as well as the treatment sections 520, 550. However, it should be understood that any of a variety of alternative configurations may be envisioned, as within the scope of the present invention, as may be desirable for a particular application.

In all other regards, it should be further understood that the assembly 500 may be configured substantially the same as any of the previously described assemblies 100 and/or 200 and/or 300 and/or 400, as may be desirable for a particular application. Further, as with assemblies 100, 200, 300, 400, various embodiments of the assembly 500 are envisioned for use with any of a variety of user limbs, although illustrated in conjunction with the non-limiting example of a user's leg.

Assembly 600

FIG. 9 is a side view, similar to that of FIG. 1 but further illustrating a knee extension assembly 600 according to various embodiments. In certain embodiments, the assembly 600 comprises at least the elements of FIG. 1, but additionally a temperature treatment extension 610. In at least the illustrated and still other envisioned embodiments, the extension 610 may be fixedly, or alternatively removably attached to at least the inflatable bladder 20.

In any of these various embodiments, the temperature treatment extension 610 includes an extended section 650 which is in fluid communication with the first temperature bladder 20. In certain embodiments, the fluid communication may be via a fluid connection section 651, while in other envisioned embodiments any of a variety of fluid connection mechanisms may be used or incorporated, as may be desirable for a particular application.

According to various embodiments, the extended section 650 may be configured so as to provide temperature treatment at the localized areas of the user's body as shown. In at least the illustrated embodiment, the extended section 650 can provide the treatment somewhat longitudinally distant from the bladder 20 location due the use of the connection section. Such a configuration may be seen is particularly useful when hot/cold fluid is used in the bladder 20 as well as the extended section 650. In such instances, along with still other envisioned embodiments, the extended section 550 may be configured so as to provide temperature treatment at the localized areas of the user's body as shown. In at least the illustrated embodiment, the extended section 650 can provide the treatment somewhat longitudinally distant from the bladder 20 location due the use of the connection section 651.

In all other regards, it should be further understood that the assembly 600 may be configured substantially the same as any of the previously described assemblies 100 and/or 200 and/or 300 and/or 400 and/or 500, as may be desirable for a particular application. Further, as with assemblies 100, 200, 300, 400, 500, various embodiments of the assembly 600 are envisioned for use with any of a variety of user limbs, although illustrated in conjunction with the non-limiting example of a user's leg.

Various Combinations of Assemblies 100, 200, 300, 400, 500, and 600

Having thus described various embodiments containing respective assemblies 100, 200, 300, 400, 500, and 600, a variety of non-limiting variations upon those embodiments, and thus assemblies will now be described. It should be understood that while these variations are exemplary for purposes of providing a legally complete disclosure, such should not be construed as limiting or exclusionary of still further alternative embodiments or combinations thereof.

According to various embodiments, one or more elements of assemblies 100, 200, 300, 400, 500, and/or 600 (as illustrated through various figures) may be configured to apply a desired temperature (e.g., hot and/or cold) therapy adjacent at least a portion of a user's limb, as may be desirable for a particular application. In certain embodiments, at least the bladder 20 and the therapy pad (e.g., 114, 214, 314, or 414) may both be filled to a fluid (e.g., hot or cold, as may be desirable) to provide thermotherapy. In other embodiments, only one or the other of the bladder and/or the therapy pad may be filled with the fluid, although both may be configured to receive such, as may be desirable for a particular application. In still other embodiments, an extended temperature treatment section (e.g., 550, 650) may be filled with the fluid, in conjunction with or instead of the bladder and/or the therapy pad. In all these and still other envisioned embodiments, it should be understood that any combination of the bladder 20, the therapy pads (e.g. only the therapy pad (e.g., 114, 214, 314, or 414), and the extended temperature treatment section (e.g., 550, 650) may be filled with a fluid (e.g., hot or cold) to provide thermotherapy. In yet still other envisioned embodiments, it should be further understood that one or more of the pads or sections may comprise an electronic heating/cooling element, instead of a temperature controlled fluid, as described elsewhere herein.

According to various embodiments, one or more elements of assemblies 100, 200, 300, 400, 500, and/or 600 may be configured to provide thermotherapy (e.g., a hot/cold fluid) via a pocket (e.g., 113, 115, as in at least FIG. 10) configured to receive hot or cold components (e.g., gel packs, inserts, elements, and the like) as needed. In certain embodiments, however, the pocket 115 may be substituted with a plurality of integral heat transfer channels (e.g., 215) passing throughout a therapy pad (e.g., 214). In at least the illustrated embodiment of FIG. 5 discloses that fluid provided into such channels (e.g., through a single input/output portion 217, as in FIG. 12) may remain in the pad for the duration of a treatment. In other embodiments, however, it should be understood that the channels (e.g., 215) may include a portion having separate input and output channels (e.g., 218, 219 of FIG. 13), thereby allowing for the fluid (e.g., hot and/or cold as may be desired) to be continuously circulated throughout the pad (e.g., 214) for the duration of a treatment. In still other embodiments, the circulation may be selectively activated or suspended, as may be desirable for a particular application. In all these and still other envisioned embodiments, it should be understood that any combination of the pockets, integral heat transfer channels having a spigot, and channels having separate input and output lines may be configured for use with any of the described assemblies 100, 200, 300, 400, 500, and/or 600.

According to various embodiments, the therapy pad (e.g., 114, 214, 314, or 414) and/or the extended temperature treatment section (e.g., 550, 650, as in at least FIGS. 8 and 9) may be configured to be selectively attached to the air bladder 20 in any of a variety of ways, largely as known and commonly used in the art. In certain embodiments, with reference to at least FIGS. 3 and 4, a pair of straps 25 may extend from the bladder 20, with at least one of the straps comprising a Velcro portion for adhering to the remaining strap upon wrapping of the straps 25 substantially around the user's limb. In other embodiments, medial and/or lateral elastic straps, as in at least FIG. 6, may be configured to connect an opposing therapy pad (e.g., 114, 214, 314, or 414) to the bladder 20. In still other embodiments, the opposing therapy pad (e.g., 114, 214, 314, or 414) and/or the extended temperature treatment section (e.g., 550, 650) may be attached with a strap of a fixed length (e.g., 417F) to either the medial or lateral side of the bladder 20, with a single strap passing through a D-ring or buckle (or alternative structure, as functional for a similar purpose) adjacent the opposing side of the bladder. The therapy pad (e.g., 114, 214, 314, or 414) may then be fixedly secured relative to the bladder 20 and adjusted, as may be desirable, depending upon a relative girth of a user's limb. In all these and still other envisioned embodiments, it should be understood that any combination of these and still other attachment mechanisms may be used to secure the therapy pad (e.g., 114, 214, 314, or 414) and/or the and/or the extended temperature treatment section (e.g., 550, 650) relative to the bladder (e.g., 20).

According to various embodiments, the therapy pad (e.g., 114, 214, 314, or 414) and/or the extended temperature treatment section (e.g., 550, 650) may be configured to be positioned at a variety of locations adjacent the user's limb, as may be desirable for particular applications. In certain embodiments, the therapy pad (e.g., 114, 214, 314, or 414) may be positioned substantially opposite of the air bladder 20 (and/or its associated cuff, as in at least FIG. 2). In other embodiments, the therapy pad may be dispensed with, replaced instead by at least one extended temperature treatment section (e.g., 550, 650), likewise configured to provide thermotherapy treatment, but at a further proximate or distal location (e.g., adjacent a joint, tendon, etc., as in at least FIGS. 8 and 9) relative to the location of the bladder 20, generally adjacent a muscle tissue being subjected to stretching. In still other embodiments, therapy pads and extended temperature treatment sections may be configured and positioned concurrently with one another.

According to various embodiments, the therapy pad (e.g., 114, 214, 314, or 414) and/or the extended temperature treatment section (e.g., 550, 650) may be configured for positioning substantially opposing the bladder 20, such that a user's limb may be insert substantially there-between, as may be seen in at least FIG. 2. In certain embodiments, although the user's limb may still be inserted there-through, at least one of the therapy pad and/or the extended temperature treatment section may be positioned adjacent the medial aspect of the user's limb. In other embodiments, the therapy pad and/or the extended temperature treatment section may be positioned adjacent the lateral aspect of the user's limb. In any of these and still other envisioned embodiments, in addition to their respective opposing, medial, and/or lateral positioning relative to the bladder 20, at least one of the therapy pad and/or the extended temperature treatment may be further configured to project proximally and/or distally relative to the specific tissues being stretched, as in at least FIGS. 8 and 9.

C. Miscellaneous Comments, Variations, Etc.

The spigot 216 according to various embodiments as previously described, and shown in at least FIG. 5, may be configured to further allow for the use of separate hot or cold water (or other liquid) to be supplied to the therapy pad 214 and/or any of the extended temperature treatment sections (e.g., 550, 650) in such alternative embodiments. In certain embodiments incorporating such a configuration, hot or cold water may be cycled continuously and/or alternatively through the channels 215 within the pad 214, as may be desirable for a particular treatment application. Although in some embodiments the cycling of the water (or other alternative fluid or liquid) may be by gravity feed (one way), other envisioned embodiments may accomplish the same by a recirculating feed (two-way). Still other envisioned embodiments could accomplish the same via any of a variety of mechanisms, as commonly known and understood in the art, as may be desirable for a particular application. One non-limiting mechanism example would be the Cryocuff configuration (see www.cryocuff.com). Still further, according to various disclosed embodiments as previously described, hot or cold modular thermotherapy elements may be used in conjunction with the present invention, instead of the use of hot or cold water or other fluid, which may be used for inflating the bladder 20. Certain non-limiting examples of such hot or cold modular thermotherapy elements include Mabis's reusable Heat/Kold gel packs that can be either placed in the freezer for cryotherapy or microwave for thermotherapy applications. In other envisioned embodiments, modular thermotherapy elements such as Thermabead pads could also be used; these provide moist heat, which may be more effective at heating collagen/connective tissue. In still other envisioned embodiments, any of a variety of thermotherapy elements may be incorporated, as may be desirable for a particular application.

According to any of the various embodiments disclosed herein and further envisioned, any of the disclosed and described pads may be constructed from a soft material that is comfortable on the skin. In certain embodiments, the material may be such that it further provides a protective barrier to over-heating and cooling, as may be desirable for a particular application.

Prior guidelines should be used for the appropriate temperature ranges for treatment, with the knowledge that much of it depends on both the medium being used and the size of the surface area that is being treated. As a non-limiting example, a warm whirlpool used to treat the entire lower extremities should be between 90 and 104 degrees F., but moist heat packs that treat a much smaller surface area are recommended to be between 160 and 170 degrees F. It should be understood that alternative temperature ranges may be envisioned as acceptable, depending upon the medium used, together with the size and/or location of the area of treatment, and/or further depending on any of a variety of factors, as may be encountered with a particular application.

### IV. CONCLUSION

Therefore it may be seen that the various embodiments of the present invention provide a plurality of devices which provide improvements over known prior art orthotic devices.

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. An orthotic device for attachment to and for manipulating a user's limb having a joint, said device comprising:
an inflatable motive bladder containing a first fluid, said bladder inflatable from a lesser inflated mode to a more inflated mode, said motive bladder configured to be positioned adjacent a first portion of said limb, said motive bladder configured to provide a motive force to move said first portion of said limb so as to cause a change in flexion or extension in said joint; and
a therapy pad adjacent a second portion of said limb, said therapy pad being separate and spaced from said motive bladder and comprising a treatment material configured to provide thermotherapy for said second portion of said limb.

2. The device as claimed in claim 1, wherein said first fluid comprises a gas.

3. The device as claimed in claim 1, wherein said first fluid comprises a liquid.

4. The device as claimed in claim 1, wherein said therapy pad comprises a treatment material being at a different temperature than said second portion of said limb, and wherein said therapy pad is configured to allow for the transfer of heat between said therapy pad and said second portion of said limb in order to facilitate a thermotherapeutic action upon said second portion of said limb.

5. The device as claimed in claim 4, wherein said therapy pad comprises a treatment material being at a temperature higher than said second portion of said limb, higher to a degree so as to provide a thermotherapeutic action upon said second portion of said limb.

6. The device as claimed in claim 4, wherein said therapy pad comprises a treatment material being at a temperature lower than said second portion of said limb, lower to a degree so as to provide a thermotherapeutic action upon said second portion of said limb.

7. The device as claimed in claim 4, wherein said treatment material in said therapy pad comprises a gel-containing container removably positioned within a pocket defined by said therapy pad.

8. The device as claimed in claim 4, wherein said treatment material in said therapy pad comprises a liquid.

9. The device as claimed in claim 4, wherein said treatment material in said therapy pad comprises a liquid contained within a plurality of passageways defined within said therapy pad.

10. The device as claimed in claim 9, wherein said liquid is circulating within the plurality of passageways, said circulation being provided by gravity.

11. The device as claimed in claim 9, wherein said liquid is circulating within the plurality of passageways, said circulation being provided by a liquid pump.

12. The device as claimed in claim 9, wherein said liquid is not circulating within the plurality of passageways.

13. The device as claimed in claim 4, wherein said treatment material in said therapy pad comprises a liquid contained within a pouch defined within said therapy pad, said liquid not being circulated within the pouch.

14. The device as claimed in claim 4, wherein said treatment material in said therapy pad comprises an electronic heating or cooling element.

15. The device as claimed in claim 4, wherein said therapy pad is positioned adjacent a limb portion opposite said bladder.

16. The device as claimed in claim 4, wherein said therapy pad is positioned adjacent a limb portion proximally positioned relative to said bladder.

17. The device as claimed in claim 4, wherein said therapy pad is positioned adjacent a limb portion laterally positioned relative to said bladder.

18. The device as claimed in claim 4, wherein said therapy pad is positioned adjacent a limb portion distally positioned relative to said bladder.

19. The device as claimed in claim 4, wherein said therapy pad is positioned adjacent a medial limb portion.

20. The device as claimed in claim 4, wherein the separate therapy pad and the inflatable motive bladder are attached relative to one another via at least one adjustable strap.

21. The device as claimed in claim 4, wherein the separate therapy pad and the inflatable motive bladder are attached relative to one another via at least an elastic material.

22. The device as claimed in claim 1, wherein the motive bladder further comprises a treatment material configured to provide thermotherapy for said first portion of said limb.

23. The device as claimed in claim 1, further comprising a separate insulation pad configured for positioning intermediate said separate therapy pad and said second portion of said limb.

24. The device as claimed in claim 23, wherein said separate insulation pad and said separate therapy pad are attached relative to one another via at least one Velcro-containing surface.

25. The device as claimed in claim 1, further comprising:
a structural assembly;
a flexible member interconnecting said structural assembly and said motive bladder, such that when said device is attached relative to said limb and said motive bladder is in said lesser inflated mode, a portion of said limb can be positioned intermediate said structural assembly and said motive bladder; and
an inflating device for inflating said motive bladder, such that as said motive bladder is inflated to said more inflated mode, said motive bladder provides said motive force upon said inserted portion of limb such that said limb is moved relative to said structural assembly in such a manner as to result in said change in flexion or extension of said joint.

26. An orthotic device for attachment to and for manipulating a user's limb having a joint, said device comprising:
an inflatable motive bladder containing a first fluid, said bladder inflatable from a lesser inflated mode to a more inflated mode, said motive bladder configured to be positioned adjacent a first portion of said limb, said motive bladder configured to provide a motive force to move said first portion of limb so as to cause a change in flexion or extension in said joint;
a first therapy pad adjacent a second portion of said limb, said first therapy pad being separate and spaced from said motive bladder and configured to provide thermotherapy for said second portion of said limb; and
a second therapy pad adjacent a third portion of said limb, said second therapy pad being separate and spaced from said motive bladder and configured to provide thermotherapy for said third portion of said limb.

27. The device as claimed in claim 26, wherein one of said first and second therapy pads includes a treatment material being a temperature higher than said limb, higher to a degree so as to provide a thermotherapeutic action upon said limb.

28. The device as claimed in claim 26, wherein one of said first and second therapy pads includes a treatment material being a temperature lower than said limb, lower to a degree so as to provide a thermotherapeutic action upon said limb.

29. The device as claimed in claim 26, wherein said first and second therapy pads each include a treatment material being a different temperature than said second and third portions of said limb, respectively and wherein said therapy pads are configured to allow for the transfer of heat between said therapy pads and said limb in order to facilitate a thermotherapeutic action upon said limb.

30. The device as claimed in claim 29, wherein one of said first and second therapy pads includes a treatment material being a temperature higher than said limb, higher to a degree so as to provide a thermotherapeutic action upon said limb.

31. The device as claimed in claim 29, wherein one of said first and second therapy pads includes a treatment material being a temperature lower than said limb, lower to a degree so as to provide a thermotherapeutic action upon said limb.

32. The device as claimed in claim 29, wherein said treatment material in one of said first and second therapy pads includes a gel-containing container removably positioned within a pocket defined by said respective therapy pad.

33. The device as claimed in claim 29, wherein said treatment material in one of said first and second therapy pads comprises a liquid circulating within a plurality of passageways defined within said therapy pad.

34. The device as claimed in claim 29, wherein said treatment material in in one of said first and second therapy pads comprises a liquid contained within a pouch defined within said therapy pad, said liquid not being circulated within the pouch.

35. An orthotic device for attachment to and for manipulating a user's limb having a joint, said device comprising:
an inflatable motive bladder containing a first fluid, said bladder inflatable from a lesser inflated mode to a more inflated mode, said motive bladder configured to be positioned adjacent a first portion of said limb, said motive bladder configured to provide motive force to move said first portion of limb so as to cause a change in flexion or extension in said joint; and
a therapy pad adjacent a second portion of said limb, said therapy pad being separate and spaced from said motive bladder and configured to provide thermotherapy for said second portion of said limb, said second portion of said limb including said joint under flexion or extension.

36. The device as claimed in claim 35, wherein said therapy pad includes a treatment material being a temperature higher than said limb, higher to a degree so as to provide a thermotherapeutic action upon at least said joint under flexion or extension.

37. The device as claimed in claim 35, wherein said therapy pad includes a treatment material being a temperature lower than said limb, lower to a degree so as to provide a thermotherapeutic action upon at least said joint under flexion or extension.

38. The device as claimed in claim 35, wherein said therapy pad includes a treatment material, said treatment material comprising a liquid circulating within a plurality of passageways defined within said therapy pad.

39. The device as claimed in claim 35, wherein said therapy pad includes a treatment material, said treatment material comprising a liquid contained within a pouch defined within said therapy pad, said liquid not being circulated within the pouch.

40. An orthotic device for attachment to and for manipulating a user's limb having a joint, said device comprising:
an inflatable motive bladder containing a first fluid, said bladder inflatable from a lesser inflated mode to a more inflated mode, said motive bladder configured to be positioned adjacent a first portion of said limb, said motive bladder configured to provide motive force to move said portion of limb so as to cause a change in flexion or extension in said joint; and
a separate therapy pad adjacent a second portion of said limb, said therapy pad being separate from said motive bladder and including a second fluid,
said first fluid configured to inflate said motive bladder and also configured to provide thermotherapy for said first portion of limb such that there is fluid communication between said motive bladder and said therapy pad.

41. An orthotic device for attachment to and for manipulating a user's limb having a joint, said device comprising an inflatable motive bladder containing a first fluid, wherein:
said bladder is configured to be positioned adjacent a portion of said limb;
said bladder is configured to provide a motive force upon said portion of said limb and cause a change in flexion or extension in said joint;
said first fluid is configured to inflate said bladder from a lesser inflated mode to a more inflated mode, so as to provide said motive force; and
said first fluid is further configured to provide thermotherapy for said portion of said limb.

42. A method of manipulating a user's limb having a joint, said method comprising the steps of:
positioning an inflatable motive bladder containing a first fluid adjacent a first portion of said limb, said bladder being inflatable from a lesser inflated mode to a more inflated mode;
positioning a separate therapy pad adjacent a second portion of said limb, said therapy pad being spaced from said motive bladder and including a treatment material configured to provide thermotherapy for said second portion of said limb; and
inflating said motive bladder from said lesser inflated mode to said more inflated mode, such that said motive bladder provides a motive force to move at least said first portion of said limb so as to cause a change in flexion or extension in said joint.

43. A method of manipulating a user's limb having a joint, said method comprising the steps of:
positioning an inflatable motive bladder containing a first fluid adjacent a first portion of said limb, said bladder being inflatable from a lesser inflated mode to a more inflated mode;
positioning a first separate therapy pad adjacent a second portion of said limb, said first therapy pad being spaced from said motive bladder and including a treatment material configured to provide thermotherapy for said second portion of said limb;
positioning a second separate therapy pad adjacent a third portion of said limb, said second therapy pad being spaced from said motive bladder and said first therapy pad, said second therapy pad including a treatment material configured to provide thermotherapy for said third portion of said limb; and
inflating said motive bladder from said lesser inflated mode to said more inflated mode, such that said motive bladder provides a motive force to move at least said first portion of said limb so as to cause a change in flexion or extension in said joint.

44. A method of manipulating a user's limb having a joint, said method comprising the steps of:
positioning an inflatable motive bladder containing a first fluid adjacent a first portion of said limb, said bladder being inflatable from a lesser inflated mode to a more inflated mode;
positioning a separate therapy pad adjacent said joint, said therapy pad being spaced from said motive bladder and including a treatment material configured to provide thermotherapy for said joint; and
inflating said motive bladder from said lesser inflated mode to said more inflated mode, such that said motive bladder provides a motive force to move at least said first portion of said limb so as to cause a change in flexion or extension in said joint.
